(19) United States
(12) Patent Application Publication
(10) Pub. No.: US 2026/0148232 A1
(43) Pub. Date: May 28, 2026

(54) 24HWS _BEI: Unified Sovereign Behavioral Infrastructure for Global Identity, Communication, Navigation, Currency Clearance, and Platform Governance

(71) Applicant: FURONG BEI, SAN GABRIEL, CA (US)

(72) Inventor: FURONG BEI, SAN GABRIEL, CA (US)

(21) Appl. No.: 19/177,594

(22) Filed: Apr. 13, 2025

(51) Int. Cl. G06Q 20/40; G06Q 40/04; H04L 67/104

(52) U.S. Cl. CPC G06Q 20/4014; G06Q 40/04; H04L 67/104; G06Q 2220/10

(57) ABSTRACT

A unified behavioral infrastructure system enabling self-sovereign identity, communication, navigation, and transactions without reliance on centralized governments, corporations, or platforms. The system includes a behavior-linked identity (BEI-ID), peer-to-peer messaging protocol, intent-based navigation layer, decentralized clearance mechanism, and modular platform interface. It replaces traditional ID systems, SIM-based messaging, GPS, SWIFT banking, and app stores with a behavior-anchored, index-driven framework for sovereign human interaction and economic activity.

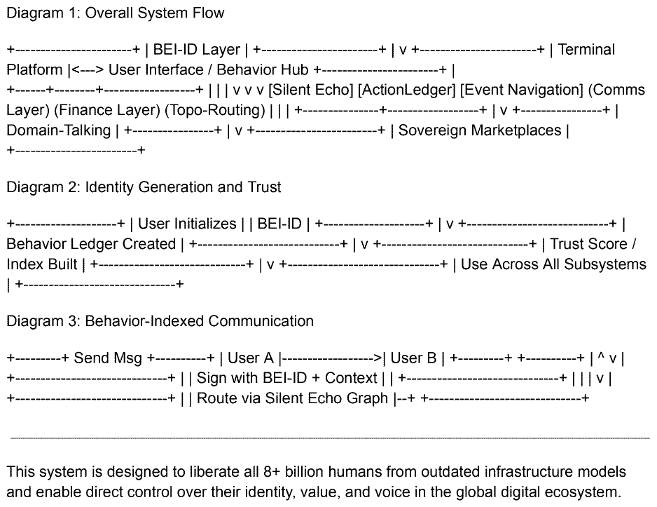

### TECHNICAL FIELD

This invention relates to distributed digital infrastructure, and more particularly to a sovereign behavioral system that integrates identity management, peer communication, navigational intent mapping, decentralized finance, and access rights governance.

### BACKGROUND OF THE INVENTION

Conventional global infrastructure relies on centralized identity issuance (e.g., passports, SIM registration), communication platforms (e.g., WhatsApp, email), navigation (e.g., GPS), financial clearance (e.g., SWIFT), and data-hosting platforms (e.g., app stores). These systems are exclusionary, fragmented, and often exploitative. They impose access barriers, extract behavioral data without compensation, and isolate users from their transactional autonomy.

This invention offers an alternative built upon behavior as proof, self-issued identity, real-time index-based value determination, and peer-to-peer communications across a sovereign digital framework.

### CLAIMS

1. A behavior-driven identity system (BEI-ID):
   A system and method for generating and maintaining a self-sovereign identity, wherein:
a. the identity is created autonomously by the individual without reliance on any centralized government, corporate, or institutional authority;
b. the identity is persistently linked to a behavioral ledger comprising verifiable records of actions, interactions, and contextual events;
c. said identity functions as a cryptographically valid reference for accessing services, proving authorship, executing transactions, and communicating securely.
2. A phone-free, SIM-free communication protocol (Silent Echo):
   A decentralized communication framework, comprising:
a. peer-to-peer message exchange using BEI-ID identifiers as communication endpoints;
b. authentication and routing of messages based on behavioral trust scores and dynamic relationship graphs;
c. integrated verification of behavioral context within each message package.
3. A decentralized clearance and transaction protocol (ActionLedger):
   A financial transaction system, wherein:
a. behavioral contributions are tokenized into transferable value units;
b. exchanges occur via smart clearance contracts indexed by behavior-driven value indices (e.g., trust, time, energy, relevance);
c. monetary flow is achieved without dependence on fiat currency, banking intermediaries, or third-party authorities.

### DESCRIPTION

This invention defines a new sovereign infrastructure system that integrates identity, communication, navigation, and economic transactions into a seamless, decentralized behavioral framework.

At its core, it recognizes behavior as the universal source of value, trust, and legitimacy. BEI-ID identities are not issued but self-generated and validated by one's chain of actions. Communication is redefined through peer-to-peer behavior-signed messaging. Navigation is contextual and event-driven. Transactions occur without banks or fiat, governed by trust indices and behavioral currency. All activities are conducted within Terminal, a modular platform replacing app stores and state-controlled portals.

This creates a living, breathing system capable of evolving with each new user, node, or behavior. It provides an unprecedented level of autonomy, scalability, and global interoperability.

### Use Cases

1. Global Stateless Identity:
   Refugees or stateless persons generate a BEI-ID to establish trust and access services across borders.
2. Phone-Free Secure Messaging:
   Users communicate without requiring SIM cards, phone numbers, or centralized apps.
3. Dynamic Urban Navigation:
   Citizens locate services, events, and peers based on behavioral presence and event context, not static maps.
4. Behavior-based Income Systems:
   Teachers, caregivers, volunteers earn currency through verified, trust-indexed behavioral contributions.
5. Sovereign Marketplaces:
   Micro-communities build entire local economies within their Terminal platform using domain-talking indexes.
6. Decentralized Voting & Governance:
   Social decisions are made transparently through behavioral proof and distributed ID validation.
7. Cross-platform Data Ownership:
   Users control access to all data, communications, and assets via their Terminal-linked BEI-ID.

### ASCII Diagrams/Flowchart Sketches (USPTO/PCT Text Format)

[ASCII diagrams retained as-is]

### Appendix A—Strategic Value Whitepaper (Non-Claim Informative Attachment)

The following section is not part of the formal patent claims or description, but is provided to support strategic and technical understanding of the invention's intended scope and systemic potential.

### BEI×24HWS: Core Value Whitepaper Summary

Title: Unified Sovereign Behavioral Infrastructure for Identity, Communication, Navigation, Currency, and Governance

Document Type: Core Value Whitepaper Summary for Strategic, Technical, and Investment Audiences

### 1. Executive Summary

The BEI×24HWS system represents a foundational reinvention of global digital infrastructure, enabling all 8+ billion people to operate outside of platform-controlled ecosystems and nation-state-issued identity systems. It is not an application. It is a protocol, an architecture, and a new sovereign operating system for civilization.

### 2. Core Innovation Claims

### A. Self-Generated Identity (BEI-ID)

No government or corporation issues the ID.
Users generate their sovereign ID based on behavioral proof.
ID is cross-platform, decentralized, and cryptographically validated.

### B. Behavior As Currency and Governance

All human action becomes measurable, indexable, and valuable.
Behaviors generate tokens and determine permission and trust.
Replaces fiat-based clearance systems and arbitrary access control.

### C. Terminal Platform Architecture

Replaces app stores, cloud platforms, and centralized interfaces.
Users own and deploy their own behavioral services.
Modular, interoperable, sovereign by design.

### 3. Strategic Value

### 1. Post-State Digital Sovereignty

Enables identity and economic interaction for stateless individuals and communities.
Fills critical gaps in refugee access, informal economies, and digital disenfranchisement.

### 2. Universal Infrastructure Replacement Layer

Replaces passport, phone number, SIM, bank account, GPS locator, and platform login with a single identity and behavioral protocol.
Offers the equivalent of a “second infrastructure stack” for humanity.

### 3. Cross-sector Use Cases

Finance: Peer-to-peer trust-based currency
Governance: Behavioral voting and consensus
Health & Education: Index-based service access
Urban Systems: Navigation and trust maps

### 4. Digital Civil Rights Framework

Establishes behavior as the basis of digital proof, not surveillance.
Redefines identity ownership and access rights in favor of individuals.

### 5. Global Deployment Potential

Particularly suited for emerging economies, decentralized organizations, humanitarian sectors, and sovereign digital nations.

### 4. Intellectual Property Positioning

Core patents include identity protocol, communication system, navigation logic, value indexing, and permission governance.
Designed to support CIP (Continuation-In-Part), divisional filings, and regional derivatives.
Defensively structured to preclude platform-level duplication by Big Tech.

### 5. Conclusion

BEI×24HWS is the constitutional architecture of post-platform civilization. It is the blueprint for a sovereign digital agency. It transforms behavior into power, identity into access, and networks into self-sustaining economies.

It is not a better app. It is a better world system.

1. A behavior-driven identity system (BEI-ID):
A system and method for generating and maintaining a self-sovereign identity, wherein:
a. the identity is created autonomously by the individual without reliance on any centralized government, corporate, or institutional authority;
b. the identity is persistently linked to a behavioral ledger comprising verifiable records of actions, interactions, and contextual events;
c. said identity functions as a cryptographically valid reference for accessing services, proving authorship, executing transactions, and communicating securely.

2. A phone-free, SIM-free communication protocol (Silent Echo):
A decentralized communication framework, comprising:
a. peer-to-peer message exchange using BEI-ID identifiers as communication endpoints;
b. authentication and routing of messages based on behavioral trust scores and dynamic relationship graphs;
c. integrated verification of behavioral context within each message package.

3. A decentralized clearance and transaction protocol (ActionLedger):
A financial transaction system, wherein:
a. behavioral contributions are tokenized into transferable value units;
b. exchanges occur via smart clearance contracts indexed by behavior-driven value indices (e.g., trust, time, energy, relevance);
c. monetary flow is achieved without dependence on fiat currency, banking intermediaries, or third-party authorities.
